(19) United States
(12) Patent Application Publication
(10) Pub. No.: US 2026/0126017 A1
(43) Pub. Date: May 7, 2026

(54) GAS TURBINE ENGINE AND METHOD OF OPERATING

(71) Applicant: General Electric Company, Evendale, OH (US)

(72) Inventors: Timothy Leo Schelfaut, Lebanon, OH (US); Cyril Moran, Loveland, OH (US); Kevin Richard Graziano, Liberty Township, OH (US); Timothy M. Kasberg, Liberty Township, OH (US); Donald Ira Goepper, III, Maineville, OH (US); Jason W. Holden, Cincinnati, OH (US)

(21) Appl. No.: 18/937,474

(22) Filed: Nov. 5, 2024

(51) Int. Cl. F02C 9/20

(52) U.S. Cl. CPC F02C 9/20; F05D 2220/323; F05D 2270/20; F05D 2270/303

(57) ABSTRACT

An assembly for an aircraft includes a gas turbine engine comprising a turbine and a casing, and a system comprising a processor and a memory, the memory storing instructions executable by the processor to determine an exhaust gas temperature based on data from one or more sensors disposed in the gas turbine engine, the exhaust gas temperature being a temperature of an airflow downstream of the turbine, determine whether the exhaust gas temperature of the gas turbine engine is within a threshold of a specified exhaust gas temperature, and upon determining that the exhaust gas temperature is outside the threshold of the specified exhaust gas temperature, control at least one of an electric machine operably connected to the turbine or an active clearance control valve to adjust a clearance between two components of the gas turbine engine until a current exhaust gas temperature is within the threshold of the specific exhaust gas temperature.

### FIELD

The present disclosure relates to gas turbine engines and methods for operating.

### BACKGROUND

Turbine engines, including gas or combustion turbine engines, and hybrid-electric gas turbine engines, are rotary engines that extract energy from a flow of combusted gases. Turbine engines generally include a compressor, combustor, and turbine in serial flow arrangement. The compressor compresses air which is supplied to the combustor where it is mixed with fuel. The mixture is then ignited to generate hot combustion gases. The combustion gases are supplied to the turbine, which extracts energy from the combustion gases for powering the compressor, as well as for producing useful work to propel an aircraft in flight or to power a load, such as an electrical generator. Hybrid-electric type turbine engines can additionally include at least one electric machine or motor that can be controlled to input or extract additional power to one of the rotating elements of the turbine engine.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of an exemplary gas turbine engine according to the present disclosure.

FIG. 2 is a schematic view of a control system for the gas turbine engine.

FIG. 3 is a schematic view of an active clearance control system for the gas turbine engine.

FIG. 4 is a block diagram of an exemplary method for controlling an exhaust gas temperature of the gas turbine engine.

FIG. 5 is a block diagram of control of a hybrid-electric gas turbine engine.

FIG. 6 is a block diagram of active clearance control of the gas turbine engine.

FIG. 7 is a block diagram of operation of the gas turbine engine with a machine learning model to determine a specified exhaust gas temperature.

FIG. 8 is a block diagram of an exemplary controller of the gas turbine engine.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

As used herein, the terms “first,” “second,” and “third” can be used interchangeably to distinguish one component from another and are not intended to signify location or importance of the individual components. The singular forms “a”, “an”, and “the” include plural references unless the context clearly dictates otherwise. Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein.

The terms “forward” and “aft”, as used herein, refer to relative positions within a hybrid-electric gas turbine engine or vehicle, and refer to the normal operational attitude of the hybrid-electric gas turbine engine or vehicle. For example, with regard to a blade, forward refers to a position closer to the leading edge of the airfoil and aft refers to a position closer to the trailing edge.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows. For example, when used in terms of fluid flow, fore/forward can mean upstream and aft/rearward can mean downstream.

Additionally, as used herein, the terms “radial” or “radially” refer to a direction away from a common center. For example, in the overall context of a turbine engine, radial refers to a direction along a ray extending between a center longitudinal axis of the engine and an outer engine circumference.

Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

As used herein, the term “fluid” as used herein can be a gas or a liquid. The term “fluid communication” means that a fluid is capable of making the connection between the areas specified.

As used herein, elements being “electrically connected,” “electrically coupled,” or “in signal communication” can include an electric transmission or signal being sent, received, or communicated to or from such connected or coupled elements. Furthermore, such electrical connections or couplings can include a wired or wireless connection, or a combination thereof.

Also, as used herein, while sensors can be described as “sensing” or “measuring” a respective value, sensing or measuring can include determining a value indicative of or related to the respective value, rather than directly sensing or measuring the value itself. The sensed or measured values can further be provided to additional components. For instance, the value can be provided to a controller module or processor, and the controller module or processor can perform processing on the value to determine a representative value or an electrical characteristic representative of said value.

A “parameter” is a value that is either measured directly from the sensors or determined based on data collected from the sensors.

An “operation condition” is a mode in which the aircraft operates, such as takeoff, cruise, or landing.

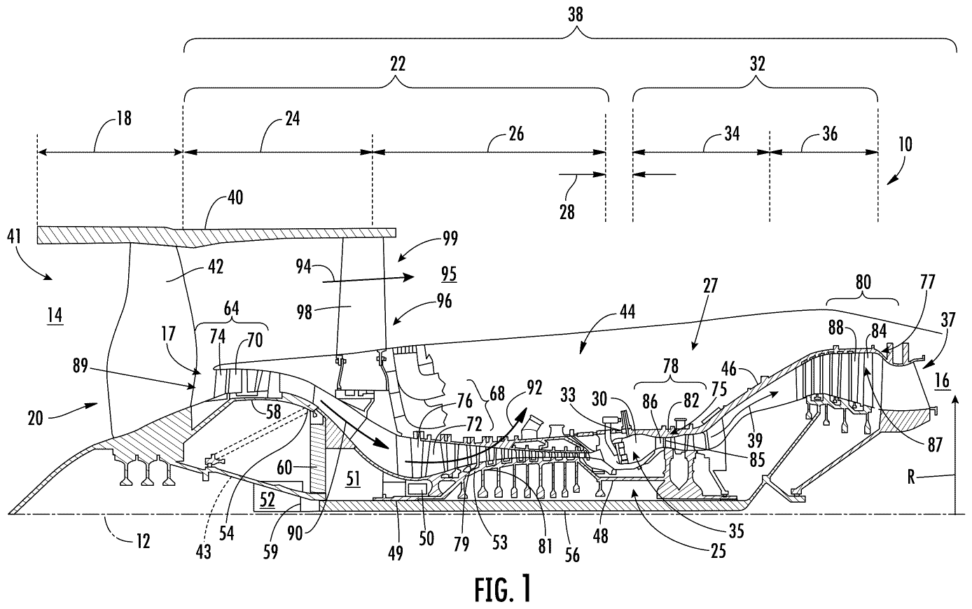

As used herein, “exhaust gas temperature” (denoted “EGT”) refers to a redline, or a maximum permitted takeoff temperature documented in a Federal Aviation Administration (“FAA”)-type certificate data sheet. For example, in certain exemplary embodiments, the term exhaust gas temperature EGT refers to a maximum permitted takeoff temperature of an airflow after a first stage stator downstream of an HP turbine of an engine. The term exhaust gas temperature EGT is sometimes also referred to as a redline exhaust gas temperature, an indicated turbine exhaust gas temperature, or an indicated turbine temperature. For example, with reference to the exemplary engine 10 discussed below with reference to FIG. 1, the term EGT refers to a temperature of an airflow after the first stator downstream of the last stage of rotor blades 82 of the HP turbine 34. In a three spool engine (as compared to the two spool engine of FIG. 1), EGT refers to a temperature of an airflow after a first stator downstream of the last stage of rotor blades of an intermediate speed turbine.

Electric machines, such as electric motors or electric generators, are used in energy conversion. In the aircraft industry, it is common to use motors and generators in various critical applications. For example, in some aircraft having a gas turbine engine, an electric machine can be used to provide power to the turbine compressor. In other instances, electric machines can combine a motor mode and a generator mode in the same device, where the electric machine operating in motor mode functions to provide an output torque to the engine, and, in generator mode, also functions as an electrical generator. Regardless of the mode, an electric machine typically includes a rotor and a stator with windings that are driven to rotate the rotor, which for some aircraft may include the gas turbine engine.

Conventional hybrid-electric gas turbine engines typically include a fan section, a compressor section, a combustor section and a turbine section. Air entering the compressor section is compressed and delivered into the combustion section, where it is mixed with fuel and ignited to generate a relatively high-temperature high-speed exhaust gas flow of combustion gasses. The high-energy exhaust gas flow expands through the turbine section to rotatably drive the compressor and the fan section. At least one electric machine (e.g., an electric motor) can supplement the rotational force provided by the high-energy exhaust gas flow from the combustor. The compressor section typically includes low and high-pressure compressors, and the turbine section includes low and high-pressure turbines. The high-pressure turbine drives the high-pressure compressor through an outer shaft to form a high-pressure spool, and the low-pressure turbine drives the low-pressure compressor through an inner shaft to form a low-pressure spool. The fan section may also be driven by the low-pressure spool inner shaft, either directly or indirectly through a fan drive gear system.

For gas turbine engines, such as hybrid-electric gas turbine engines, engine efficiency can depend at least in part on clearances between rotating and stationary components, such as a rotating turbine blade and a stationary casing surrounding the turbine blade. As used herein, the term “clearance” refers to a gap or space defined between two components, such as a rotating part and an adjacent stationary part, two rotating parts, or two adjacent stationary parts. For example, as used herein, the term “clearance” such as a “blade tip clearance” can refer to a clearance or gap between a respective tip (e.g., a radially outward tip) of one or more blades (e.g., a turbine blade) and an immediately adjacent casing (e.g., a radially inward surface of the casing). In another non-limiting instance, the term “clearance” can refer to a clearance or gap between a respective set of seal teeth and a rub element of a compressor vane. Typically, the tighter or smaller the clearance or gap between rotating and stationary parts (e.g., the tips of the blades and the casing), the more efficiently the gas turbine engine can be operated. Thus, it is generally desirable to minimize clearances to optimize the gas turbine engine performance and efficiency.

One challenge in minimizing the blade tip clearance is that the high-temperature combustion gas flow typically impacts the rotating turbine blades prior to impacting the stationary casing that circumferentially surrounds the turbine blades, resulting in different rates of thermal expansion and contraction of the rotating turbine blades and the stationary casings. Furthermore, the thermal response of the casing, blades, and rotor can occur at different rates that are dependent on the transient thermal environment of the respective parts. This can be particularly challenging when thrust demand is rapidly increased or decreased, rapidly increasing or decreasing the temperature of the high-energy exhaust gas flow from the combustor. Accordingly, gas turbine engines typically employ clearances, such as blade tip clearances, that are larger than needed for optimized engine performance and efficiency because they are sized to account for relatively rapid expansion of the turbine blades occurring due to transient engine bursts and acceleration. The changes in clearances may result in changes to an exhaust gas temperature, which may also indicate whether the gas turbine engine needs service or repair.

In some instances, gas turbine engines are controlled such that the rate of thrust increase of the engine is limited, for example by limiting or gradually increasing the rotor speed acceleration in accordance with a predetermined maximum rate of increase of acceleration, which allows blade tip clearance closure to be minimized by offsetting component mechanical and thermal deflections. This advantageously allows the blade tip clearances to be set more closely than they would be otherwise, and consequently, better engine efficiency can be achieved during cruise operation. However, limiting the rate of thrust increase of the engine decreases the responsiveness of the engine, which pilots and aircrew personnel may find undesirable. Furthermore, limiting the rate of thrust of the engine by limiting or gradually increasing the fuel flow to the combustor, simultaneously effects the rate of increase of both the high-pressure spool and low-pressure spool, regardless of the relative size of the blade tip clearances on the high and low-pressure spools.

Thus, a gas turbine engine that addresses one or more of the challenges noted above would be beneficial. Further, a method of operation of a hybrid-electric gas turbine engine that addresses one or more of the challenges noted above would likewise be useful. One way to address these challenges is to monitor and control the exhaust gas temperature of the gas turbine engine, such as by controlling components of the hybrid-electric gas turbine engine or controlling the blade tip clearances. Such control of the exhaust gas temperature can improve operation of the gas turbine engine by reducing wear on engine components and extending time on wing.

Referring now to the drawings, wherein identical numerals indicate the same elements throughout the figures, FIG. 1 is a schematic view of a gas turbine engine 10. The gas turbine engine 10 can be mounted to an aircraft (not shown), such as a fixed-wing aircraft, and can produce thrust for propulsion of the aircraft. The gas turbine engine 10 has a centerline or longitudinal axis that can define an axis of rotation 12 for the gas turbine engine 10. The axis of rotation 12 can extend longitudinally forward 14 to aft 16. For reference, the gas turbine engine 10 also defines a radial direction R and a circumferential direction. In general, the radial direction R extends outward from and inward to the axis of rotation 12 in a direction orthogonal to the axis of rotation 12, and the circumferential direction extends three hundred sixty degrees (360°) around the axis of rotation 12.

The gas turbine engine 10 includes, in downstream serial flow relationship, a fan section 18 including a fan assembly 20, a compressor section 22 including a booster or low-pressure (LP) compressor 24 and a high-pressure (HP) compressor 26, a combustion section 28 including a combustor 30, a turbine section 32 including a HP turbine 34, and a LP turbine 36, and an exhaust section 37. A turbine core 38 can be defined by the compressor section 22, the combustion section 28, the turbine section 32, and the exhaust section 37. The HP compressor 26 and HP turbine 34 can be drivingly coupled via a rotatable HP shaft 48 (e.g., a high-speed shaft) to define an HP spool 27. The LP compressor 24 and LP turbine 36 can be drivingly coupled via a rotatable LP shaft 56, (e.g., a low-speed shaft), to define an LP spool 25. The HP shaft 48 and the LP shaft 56 can be disposed coaxially about the hybrid-electric gas turbine engine axis of rotation 12. Additionally, the LP shaft 56 can be disposed within a larger diameter annular HP shaft 48, to drivingly connect the LP turbine 36 to the LP compressor 24 and fan assembly 20.

The fan section 18 includes a tubular fan casing 40 surrounding the fan assembly 20. The tubular fan casing 40 can define an annular air inlet 41. The fan assembly 20 includes a plurality of fan blades 42 disposed radially about the hybrid-electric gas turbine engine axis of rotation 12. Fan supports 43 can include, by way of non-limiting example, one or more of rotatable or non-rotatable stabilizers, bearings, sensors, or connecting shafts.

The HP compressor 26, the combustor 30, and the HP turbine 34 form an engine core 44. The turbine core 38, which can include the engine core 44, can be surrounded by a core casing 46. The core casing 46 can be a tubular shape disposed coaxially about the axis of rotation 12. In non-limiting aspects, the core casing 46 can be considered to enclose the compressor section 22, the combustion section 28, the turbine section 32. The core casing 46 can define an annular core air inlet 17. The core casing 46 can enclose and support the LP compressor 24 for pressurizing air that enters through the core air inlet 17. In some aspects, the core casing 46 can be coupled with the fan casing 40.

The compressor section 22 and turbine section 32 can have multiple respective stages, with the stages comprising respective pairs of blades and vanes. More specifically, the LP compressor 24 and the HP compressor 26 respectively include a set of compressor stages 64, 68, in which a set of compressor blades 70, 72 can rotate relative to a corresponding set of static compressor vanes 74, 76, (e.g., a nozzle), to compress or pressurize the stream of fluid passing through the stage. In a single compressor stage 64, 68, multiple compressor blades 70, 72 can be provided in a ring and can extend radially outwardly relative to the hybrid-electric gas turbine engine axis of rotation 12, from a blade platform to a blade tip, while the corresponding static compressor vanes 74, 76 are positioned upstream of and adjacent to the rotating compressor blades 70, 72. The static compressor vanes 74, 76 can comprise an airfoil body having a chord, camber, and other elements typical to an airfoil. A radially inward portion of the static compressor vanes 74, 76 can include a seal having a rub element 79 and a set of seal teeth 53 disposed adjacent to rub element 79. The seal teeth 53 can be slightly spaced from the rub element 79 such that a seal teeth clearance 81 is disposed between the radial extent of the seal teeth 53 and the rub element 79. The seal teeth clearance 81 can permit a volume of air to flow between the seal teeth 53 and the rub element 79. It is noted that the number of blades, vanes, and compressor stages shown in FIG. 1 were selected for illustrative purposes only, and that other numbers are possible.

The compressor blades 70, 72 for a stage of the compressor can be mounted to a disk 58, which is mounted to the corresponding one of the HP and LP shafts 48, 56, with each stage having its own respective disk 58. In some aspects, the compressor blades 70, 72 may be part of a blisk, rather than being mounted to a disk. The static compressor vanes 74, 76 for a stage of the compressor can be mounted to the core casing 46 in a circumferential arrangement.

The combustor 30 can define a combustion chamber 35 that is annular and generally coaxial with the axis of rotation 12. The combustor 30 can further include a fuel nozzle 33 arranged in fluid communication with the combustion chamber 35. An igniter (not shown) can provide for ignition of the fuel and air within the combustion chamber in a known manner. An exhaust outlet (not shown) can be configured to allow exit of combustion gases 39 from the combustion chamber 35 in an axial direction.

The HP turbine 34 and the LP turbine 36 respectively include a plurality of turbine stages 78, 80, in which a set of turbine blades 82, 84 are rotated relative to a corresponding set of static turbine vanes 86, 88, to extract energy from the stream of fluid passing through the stage. The HP turbine blades 82 for a stage of the turbine can be mounted to the HP shaft 48. The LP turbine blades 84 for a state of the turbine can be mounted to the LP shaft 56. In a single turbine stage 78, 80, multiple turbine blades 82, 84 can be provided in a ring and can extend radially outwardly relative to the hybrid-electric gas turbine engine axis of rotation 12, from a blade platform at a radially inner end of the turbine blades 82, 84 to a blade tip 85, 87 at a radially outer end of the turbine blades 82, 84, while the corresponding static turbine vanes 86, 88 are positioned upstream of and adjacent to the rotating blades 82, 84. The static turbine vanes 86, 88 can be mounted to the core casing 46 in a circumferential arrangement.

A first gap or HP turbine blade tip clearance 75 can be defined between the blade tips 85 of the HP turbine blades 82 and a radially inward surface of the core casing 46. A second gap or LP turbine blade tip clearance 77 can be defined between the blade tips 87 of the LP turbine blades 84 and the radially inward surface of the core casing 46.

Complementary to the rotor portion, the stationary portions of the gas turbine engine 10, such as the static compressor vanes 74, 76 and the static turbine vanes 86, 88 among the compressor section 22 and turbine section 32 are also referred to individually or collectively as an outer rotor/stator. As illustrated, the outer rotor/stator can refer to the combination of non-rotating elements throughout the gas turbine engine 10. Alternatively, the outer rotor/stator that circumscribes at least a portion of the inner rotor/stator, can be designed to rotate. The inner or outer rotor/stator can include at least one component that can be, by way of non-limiting example, a shroud, vane, nozzle, nozzle body, combustor, hanger, or blade, where the at least one component is a plurality of circumferentially arranged component segments having confronting pairs of circumferential ends.

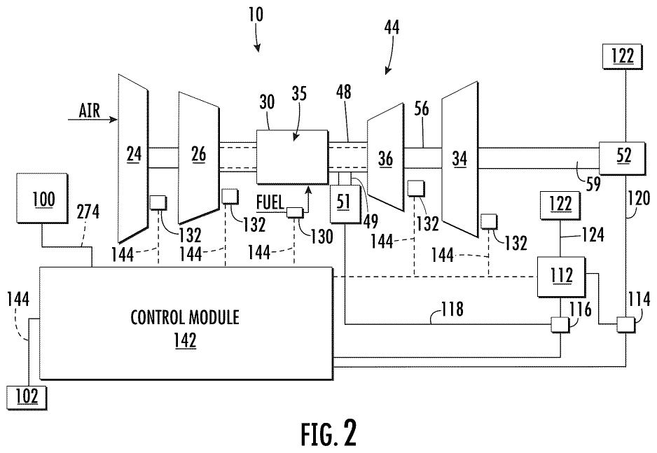

The gas turbine engine 10 may be a hybrid-electric gas turbine engine that utilizes one or more electric machines to supplement or restrict power output. In the example of FIG. 1, the gas turbine engine 10 can further include a first electric machine 51 (e.g., a first motor-generator) and a second electric machine 52 (e.g., a second motor-generator). The first electric machine 51 can be operably connected to the HP shaft 48 (such as by rotatable coupling), and the second electric machine 52 can be operably connected to the LP shaft 56 (such as by rotatable coupling). The first and second electric machines 51, 52 can be selectively electrically coupled to one or more electrical power sources 112 (shown in FIG. 2), such as an inverter. The first and second electric machines 51, 52 can be selectively electrically coupled to a set of electrical loads 131 (shown in FIG. 2) such as a respective battery bank or resistive load. Although FIG. 1 depicts the first and second electric machines 51, 52 as being operatively coupled to the HP shaft 48 and LP shaft 56, respectively, at a fore end of the hybrid-electric gas turbine engine, the first and second electric machines 51, 52 can be disposed at any suitable location.

The first and second electric machines 51, 52 can each be one or more of a starter, a starter generator, a generator, a motor, a motor-generator, or a combination thereof. The first and second electric machines 51, 52 can include one or more devices that use electromagnetic forces and can include at least one respective drive shaft. It is further contemplated that the first and second electric machines 51, 52 can include any number of gears, shafts, transformers, magnetics, brushes, induction devices, or other electrical or mechanical elements.

In the illustrated example, the first electric machine 51 has a rotatable first input/output shaft 49 rotatably coupled to the HP shaft 48, and the second electric machine 52 has a rotatable second input/output shaft 59. The HP shaft 48 can couple the HP turbine 34 to the first input/output shaft 49 and the LP shaft 56 can connect the LP turbine 36 to the second input/output shaft 59. In non-limiting aspects, the first and second electric machines 51, 52 can be selectively coupled to the HP and LP shafts 48, 56 via a first clutch 50 and a second clutch 60, respectively. Additionally, or alternatively, it is contemplated that the first electric machine 51 can further include a first gearbox (not shown) and the second electric machine 52 can include a second gearbox (not shown). The first gearbox can couple the first input/output shaft 49 to the HP shaft 48 or the first clutch 50 where the first clutch 50 selectively engages the HP shaft 48. The second gearbox can couple the second input/output shaft 59 to the LP shaft 56 or the second clutch 60 where the second clutch 60 selectively engages the LP shaft 56. In other non-limiting aspects, the either the first or second clutch 50, or the first or second gearbox, or combinations thereof can be omitted.

While FIG. 1 depicts the first and second electric machine 51, 52 selectively rotatably coupled to the HP and LP shafts 48, 56, other aspects are not so limited, and the first and second electric machine 51, 52 can be fixedly or permanently rotatably coupled to the HP and LP shafts 48, 56 respectively. The rotatable coupling between the HP shaft 48 and the first electric machine 51, and the rotatable coupling between the LP shaft 56 and the second electric machine 52, can thus be permanent including rotatably permanent.

It is contemplated that the HP shaft 48 can be coupled to the first electric machine 51, and the LP shaft 56 can be coupled to the second electric machine 52, at any point or location, including a bottom portion, top portion, or aft side of the first and second electric machine 51, 52, respectively. It is further contemplated that the first electric machine 51 can be located in-line with the HP shaft 48, and the second electric machine 52 can be located in-line with the LP shaft 56.

The first clutch 50 and the second clutch 60 can be a respective over-running clutch that is in direct rotational communication with the first electric machine 51 and second electric machine 52, respectively, to selectively provide an output to the HP shaft 48 and LP shaft 56. Alternatively, the first and second clutch 50, 60 can include any type or combination of clutch mechanisms, such as, but not limited to one or more of a sprag, spring, a roller or ball, a ratchet and pawl clutch, or other known clutches.

As will be described in more detail herein, electrical energy from the first and second electric machines 51, 52 can be selectively communicated to the set of electrical loads 131.

In operation, for example during a cruise mode, an incoming airflow 89 (represented by an arrow) enters the gas turbine engine 10 at the fan section 18 through the annular air inlet 41 defined by the fan casing 40. The incoming airflow 89 passes through the fan blades 42 and is split such that a portion of the airflow is channeled into the LP compressor 24, as a first airflow 90 (represented by an arrow) through the core air inlet 17. The incoming airflow 89 exits the fan section 18, which then supplies the first airflow 90 as a pressurized first airflow 90 to the HP compressor 26, which further pressurizes the air. A portion 94 of the airflow 89 bypasses the LP compressor 24 and the engine core 44 through a bypass passage 95 and exits the gas turbine engine 10 through a stationary vane row, and, more particularly, an outlet guide vane assembly 96 including a set of airfoil guide vanes 98, at the fan exhaust side 99. More specifically, a circumferential row of radially extending airfoil guide vanes 98 are utilized adjacent the fan section 18 to exert some directional control of the portion 94.

The pressurized first airflow 90 is discharged from the HP compressor 26 into the combustor 30. Fuel can be injected from the fuel nozzle 33 to mix with the first airflow 90 and form a fuel-air mixture provided to the combustion chamber 35 for combustion ignition of the fuel-air mixture can be triggered by the igniter (not shown) generating combustion gases 39. Some work is extracted from these combustion gases 39 by the HP turbine 34, which drives the HP compressor 26. The combustion gases are drivingly discharged into the LP turbine 36, and the exhaust gas is ultimately discharged from the gas turbine engine 10 via the exhaust section 37 to produce thrust.

A portion of the pressurized first airflow 90 can be drawn from the compressor section 22 as bleed air 92. The bleed air 92 can be drawn from the pressurized first airflow 90 and provided to engine components requiring cooling. The temperature of pressurized first airflow 90 entering the combustor 30 is significantly increased. As such, cooling provided by the bleed air 92 is necessary for operating of such engine components in the heightened temperature environments. Some of the air supplied by the fan assembly 20 can bypass the engine core 44 and be used for cooling of portions, especially hot portions, of the gas turbine engine 10, or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

Based on the rotatable coupling between the HP and LP shafts 48, 56 to the first and second /put/ output shafts 49, 59, respectively, when a portion of the first or second electric machine 51, 52 is rotating, then the HP or LP shafts 48, 56 rotate. Conversely, when the HP or LP shafts 48, 56 rotate, then at least a portion of the first or second electric machines 51, 52, respectively, rotate. Therefore, in operation, the first electric machine 51 can drive the HP shaft 48 by providing a rotatable output or torque to the HP shaft 48 via the first input/output shaft 49, and the second electric machine 52 can drive the LP shaft 56 by providing a rotatable output or torque to the LP shaft 56 via the second input/output shaft 59. Alternatively, the first electric machine 51 can receive a rotatable input or torque from the first input/output shaft 49, and the second electric machine 52 can receive a rotatable input or torque from the second input/output shaft 59 for the generation of electrical energy.

In an aspect, and as will be described in more detail herein, the first electric machine 51, or the second electric machine 52, or both, can be respectively configured to selectively operate in one of a motor mode and a generator mode. For example, the first and second electric machines 51, 52 can be arranged receive electrical power to independently operate in a motor mode to provide an output torque to the HP and LP shafts 48, 56 via the first and second input/output shafts 49, 59, for example to start the engine, or to provide additional thrust to the HP and LP shafts 48, 56 when needed. That is, rotation of the first or second electric machine 51, 52 can cause the first or second electric machine 51, 52 to provide torque to the HP or LP shafts 48, 56, respectively, such that a rotational speed of the HP or LP shaft 48, 56 is changed (e.g., increased) changing a thrust provided by the gas turbine engine 10. The rotational speed of the HP shall 48 and LP shaft 56 can be changed (e.g., increased) independent of the other of the HP or LP shaft 48, 56. Alternatively, the first and second electric machines 51, 52 can selectively receive an input torque from the HP and LP shafts 48, 56, via the first and second /put/ output shafts 49, 59 respectively, and operate in a generator mode to generate electrical power utilizing the rotational energy of the HP or LP shaft 48, 56, for example to provide an electrical output. In such instances, rotation of the first or second electric machine 51, 52 by the HP or LP shafts 48, 56, respectively, provides a drag or rotational load on the HP or LP shafts 48, 56, respectively, such that a rotational speed of the HP or LP shaft 48, 56 is changed (e.g., decreased) changing a thrust provided by the gas turbine engine 10. The rotational speed of the HP shaft 48 and LP shaft 56 can be changed (e.g., increased or decreased) independent of the other of the HP or LP shaft 48, 56.

FIG. 2 is a schematic diagram of the exemplary gas turbine engine 10 of FIG. 1. The gas turbine engine 10 includes one or more components, including a thrust input device 100, an electrical power system 110, one or more fuel control devices 130, one or more sensors 132, and a control system 140.

The thrust input device 100 adjusts thrust output of the gas turbine engine 10 based on changes to thrust demand. The thrust input device 100 may include manual devices (such as power or thrust levels movable by a user in a cockpit) and a flight control system 102 (such as an autopilot system). The thrust input device 100 is operable to change thrust output based on changes in thrust demand and to provide data indicating the change in thrust demand and output.

In operation, the gas turbine engine 10 is operable to produce propulsive thrust (e.g., for an aerial vehicle). A user, such as a pilot, can initiate a change in the thrust (i.e., a thrust demand) output of the gas turbine engine 10, for example, via the thrust input device 100. The change in thrust demand can be an increase in thrust demand or a decrease in thrust demand. For instance, to perform a step climb during cruise operation, a pilot can operate the thrust input device 100 to increase the power level and consequently change the thrust demand to the gas turbine engine 10. It will be appreciated that the change in thrust demand can correlate to a change in the rotational speed of the HP shaft 48 or LP shaft 56 or both. The change in the rotational speed of the HP shaft 48 and LP shaft 56 can be an acceleration or a deceleration.

The electrical power system 110 provides electricity to components of the gas turbine engine 10. Specifically, the electrical power system 110 includes one or more electrical power sources 112, a first electrical control device 114, and a second electrical control device 116. For instance, the first and second electrical control devices 114, 116 may include a set of inverters, converters, variable frequency drives (VFD), rectifiers, devices operable to control the flow of electrical current, etc., and combinations thereof. Although the first and second electrical control devices 114, 116 are shown schematically in FIG. 2 as separate from the electrical power source 112, and separate from the first and second electric machine 51, 52, it will be appreciated that one or both of first and second electrical control devices 114, 116 can be located onboard the electrical power source 112, the first electric machine 51, the second electric machine 52, or combinations thereof.

The first and second electric machines 51, 52 can be selectively electrically coupled with the one or more electrical power sources 112, e.g., via a first power bus 118, and a second power bus 120. The first and second electric machines 51, 52 can be further selectively electrically coupled with the set of electrical loads 122, e.g., via a third power bus 124. The first and second electric machines 51, 52 can be configured to receive electrical power from the one or more electrical power sources 112. The one or more electrical power source 112 can be any suitable power source. For example, the one or more electrical power source 112 can be, without limitation, one or more energy storage device (e.g., one or more batteries), electric generator, auxiliary power unit WU), photovoltaic panel, DC power supply, AC power supply, or any other known source of electrical power, or a combination thereof. The one or more electrical power source 112 can be located onboard the gas turbine engine 10, or mounted or positioned offboard of the gas turbine engine 10.

The set of electrical loads 122 can include for example, without limitation, a battery bank, lighting, pump, heater, instrument, radio, flap, landing gear, or other systems or operative structures.

The fuel control devices 130 control fuel flow to the gas turbine engine 10. Specifically, the fuel control devices 130 control fuel provided to the combustion chamber 35 of the combustor 30, such as an amount of fuel, a timing of fuel injection into the combustion chamber 35, an air/fuel ratio, or combinations thereof.

The one or more sensors 132 collect data about components of the gas turbine engine 10. For instance, one or more sensors 132 can be positioned at the LP compressor 24, one or more sensors 132 can be positioned at the HP compressor 26, one or more sensors 132 can be positioned at the HP turbine 34, and one or more sensors 132 can be positioned at the LP turbine 36, among other possible locations. The sensors 132 can sense or measure various engine conditions, e.g., pressures and temperatures, and one or more signals may be provided from the set of sensors 132 to the control system 140 for processing. It will be appreciated that the gas turbine engine 10 can include any number of sensors 132 at other suitable stations along the core air flow path.

The gas turbine engine 10 includes the control system 140. The control system 140 is operable to control an operation of the gas turbine engine 10. More specifically, the control system 140 includes a control module 142 that is communicatively coupled to the thrust input device 100, the electrical power system 110, the fuel control devices 130, and the sensors 132 for receiving and sending data and instructions.

The control module 142 can be a system of controllers or a single controller. More specifically, the control module 142 can be a controller dedicated to control of an operation of the gas turbine engine 10 and associated electrical components, or can be an engine controller configured to control the gas turbine engine 10 and its associated electrical components. The control module 142 can be, for example, an Electronic Engine Controller (EEC) or an Electronic Control Unit (ECU) of a Full. Authority Digital Engine Control (FADEC) system.

The control module 142 can receive one or more inputs 144. The inputs 144 can be in the form of analog or digital electrical signals. For example, the control module 142 can receive an input 144 from the thrust input device 100, or the flight control system 102, indicative of the change in thrust demand. Additionally, the control module 142 can receive one or more inputs 144 indicative of one or more parameters of the gas turbine engine 10. The control module 142 can receive the one or more inputs 144 from one or more sensors 132, via a user input, from control logic operable to calculate the value of the parameters or conditions based at least in part on the received sensor outputs, from one or more models, or automatically based on commands from a flight control system 102, and various combinations thereof.

For example, in non-limiting aspects, the parameters that can be sensed, calculated, or modeled include, without limitation, a HP turbine blade tip clearance, a LP turbine blade tip clearance, a fan blade tip clearance, a seal tooth clearance, an altitude, an ambient temperature, an exhaust gas temperature, a compressor discharge temperature, an inlet low-pressure compressor temperature, a specific fuel consumption, an engine efficiency, a Mach number, a thrust, an airspeed, a fan flow, a core flow, a current electrical current draw of the first and second electric machines 51, 52, a fan speed, a core speed, an engine inlet pressure, a bypass passage pressure, an inlet high-pressure compressor pressure, a compressor discharge pressure, a high-pressure turbine pressure, an accelerometer measurement, a flight control position, or one or more waypoints of a mission (e.g., the origin, the destination, and one or more points therebetween), and the like.

The control module 142 can further control the first and second electric machines 51, 52 to selectively operate in one of the motor mode and the generator mode. The first and second electric machines 51, 52 can be selectively operated in the motor mode in response to the electrical power received from the at least one electrical power source 112. Alternatively, the first and second electric machines 51, 52 can be selectively operated in the generating mode in response to a rotation of the HP and LP shafts 48, 56 coupled to the first and second electric machines 51, 52.

For example, to selectively operate the first and second electric machines 51, 52 in the motor mode, the control module 142 can be configured to control the first electrical control device 114 and the second electrical control device 116 to selectively provide electrical power to the first or second electric machines 51, 52 via the first and second power buses 118, 120, or both. Conversely, to selectively operate the first and second electric machines 51, 52 in the generator mode, the control module 142 can be configured to control the first electrical control device 114 and the second electrical control device 116 to selectively cease providing electrical power to the first and or second electric machines 51, 52 during a rotation of the HP shaft 48 or LP shaft 56.

When operating in the motor mode, the first and second electric machines 51, 52 can independently provide a torque to the HP and LP shafts 48, 56 via the first and second input/output shafts 49, 59. Conversely, when operating in the generator mode, the first and second electric machines 51, 52 can receive a torque from the HP and LP shafts 48, 56, via the first and second input/output shafts 49, 59, respectively, and provide an electrical output to set of electrical loads 122.

More specifically, when operating in the motor mode, the energy suppled to the first and second electric machines 51, 52 (e.g., from the first and second electrical control devices 114, 116) rotates one or more respective components of the first and second electric machines 51, 52 resulting in a rotation of the respective first or second input/output shaft 49, 59. Since the first and second input/output shafts 49, 59 are coupled to the HP shaft 48 and LP shaft 56, respectively, the first and second electric machines 51, 52 can provide a torque to rotate the HP shaft 48 and LP shaft 56. The rotation of the HP shaft 48 rotates the respective blades 72, 82 of the HP compressor 26 and HP turbine 34. The rotation of the LP shaft 56 results in the rotation of the respective blades 70, 84 of the LP compressor 24 and the LP turbine 36. Conversely, when operating in the generator mode, the electrical power supplied to the first and second electric machines 51, 52 (e.g., from the first and second electrical control devices 114, 116) can be cut off. Since the first and second input/output shafts 49, 59 are coupled to the rotating HP shaft 48 and LP shaft 56, respectively, the rotating HP shaft 48 and LP shaft 56 can drive a rotation of the first and second electric machines 51, 52.

The gas turbine engine 10 may include one or more variable geometry components 150. In this context, a “variable geometry component” is a component that can be actuated to two or more different shapes or arrangements to provide different operation. Examples of variable geometry components include variable stator vanes, variable stator inlet guide vanes, variable bleed valves, customer or domestic bleed valves, modulating turbine cooling systems, third stream modulated doors, variable pitch fan blades, or combinations thereof. The control module 142 may actuate one or more variable geometry components 150 based on the EGT. As an example, the control module 142 may actuate a variable bleed valve that removes air from the compressor section 22. For example, the control module 142 may actuate the variable bleed valve when the EGT exceeds a threshold (such as 1500° F.) to reduce the rate at which the EGT increases.

The control module 142 may collect data about an exhaust gas temperature (EGT) from one or more of the sensors. EGT may be a metric that is useful for determining service needs of the gas turbine engine 10. During certain engine operation conditions, such as takeoff, EGT reaches a transient peak that can be affected by certain clearances, such as an HP turbine blade tip clearance 75 or an LP turbine blade tip clearance 77. Systems such as an active clearance control (ACC) system can use the first and second electric machines 51, 52 to adjust the blade tip clearances 75, 77 to control EGT to within a target EGT. That is, adjusting the ACC system can result in changes to the EGT, and thus, when the EGT deviates from a target EGT, the control module 142 can actuate the first and second electric machines 51, 52 and/or the variable geometry components 150 to adjust the HP turbine blade tip clearance 75 or the LP turbine blade tip clearance 77 to return the EGT to the target EGT. As an example, the target EGT may be 1500° F., and when the determined EGT increases above the target EGT (e.g., to 2000-2500° F.), the control module 142 may actuate the first and second electric machines 51, 52.

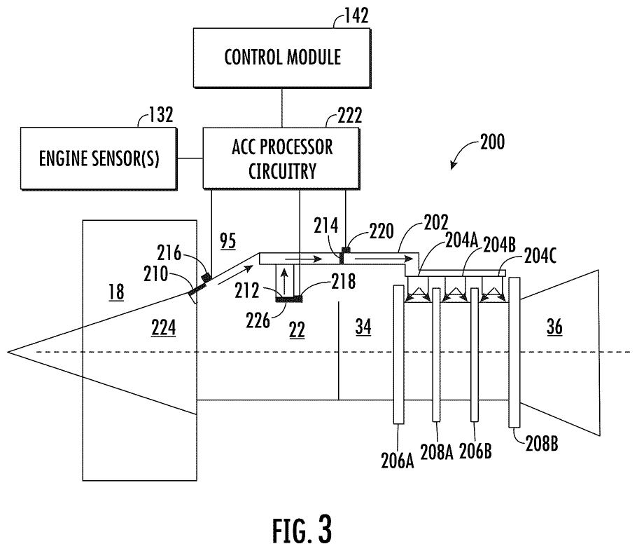

FIG. 3 is a schematic cross-sectional view of an example active clearance control (ACC) system 200 that can be utilized in the example gas turbine engine 10 of FIG. 1. The example ACC system 200 includes a first pipe 202 (e.g., a conduit, a duct, a tube, etc.), the HP turbine 34, the LP turbine 36, manifolds 204A, 204B, 204C, flanges 206A, 206B, and mid-rings 208A, 208B. In addition, the ACC system 200 includes a first inlet valve 210, a second inlet valve 212, and a mid-pipe valve 214 operatively coupled to the first pipe 202, collectively, “active clearance control valves” or “ACC valves” 210, 212, 214. The example ACC system 200 also includes first actuators 216 operatively coupled to the first inlet valve 210, second actuators 218 operatively coupled to the second inlet valve 212, and third actuators 220 operatively coupled to the mid-pipe valve 214. Furthermore, the example ACC system 200 includes ACC processor circuitry 222 operatively coupled to the respective actuators 216, 218, 220, to engine sensors 132, and to the control module 142. More specifically, the control module 142 provides instructions to the ACC processor circuitry 222 to actuate one or more components of the ACC system, such as the actuators 216, 218, 220, the first inlet valve 210, the second inlet valve 212, the mid-pipe valve 214, or combinations thereof.

Example ACC systems may include a different quantity of the first inlet valve 210, the second inlet valve 212, or the mid-pipe valve 214 along with their respective actuators 216, 218, 220, as discussed in further detail below in association with FIGS. 2B-2F. In some examples, the quantity of the first inlet valve 210, the second inlet valve 212, or the mid-pipe valve 214 that an example ACC system includes may depend on a configuration of a pipe of the ACC system (e.g., the first pipe 202) or a precision with which the example ACC system is to control air being utilized to control blade clearance.

In the illustrated example of FIG. 3, the airflow in the first pipe 202 is shown by the arrows in FIG. 3. As shown, the first pipe 202 delivers the air from the fan section 18, the bypass passage 95, or the compressor section 22 (e.g., the LP compressor 24 or the HP compressor 26) to the manifolds 204A, 204B, 204C. In turn, the manifolds 204A, 204B, 204C evenly distribute the air from the fan section 18, the bypass passage 95, or the compressor section 22 to the HP turbine 34 or the LP turbine 36. The flanges 206A, 206B and mid-rings 208A, 208B are joined to outer surfaces of a case of the HP turbine 34 or a case of the LP turbine 36. The flanges 206A, 206B and mid-rings 208A, 208B are configured to contract radially inward or expand radially outward in response to encountering changes in temperature (e.g., changes in temperature caused by the air from the manifolds 204A, 204B, 204C, changes in temperature caused by combustion gases flowing through the HP turbine 34 or the LP turbine 36, etc.). As such, the manifolds 204A, 204B, 204C direct at least some of the air that flows through the first pipe 202 to impinge on the surfaces of the flanges 206A, 206B and mid-rings 208A, 208B to affect the contraction inward or the expansion outward of the flanges 206A, 206B and the mid-rings 208A, 208B. As a result, the contraction inward or the expansion outward of the flanges 206A, 206B and the mid-rings 208A, 208B can change blade tip clearances in the HP turbine 34 or the LP turbine 36.

In the illustrated example of FIG. 3, the first inlet valve 210 is positioned at a first inlet 224 of the first pipe 202. The first inlet 224 receives air from (e.g., is in fluid connection with) a fan section 18 or a bypass passage 95. In the illustrated example, a position (e.g., a configuration, an orientation, etc.) of the first inlet valve 210 affects a rate at which the air enters the first pipe 202 through the first inlet 224, as discussed in further detail below. As such, the first inlet valve 210 can affect a rate at which the air impinges on the surfaces of the flanges 206A, 206B and mid-rings 230A. 230B to help control the blade tip clearances in the HP turbine 34 or the LP turbine 36, or both.

In particular, the first inlet valve 210 includes vanes positioned across the first inlet 224. When the first inlet valve 210 is at least partially open, the vanes define a cross-sectional area through which the air from the fan section 18 or the bypass passage 95 can enter the first pipe 202 through the first inlet 224. Specifically, the vanes can be oriented in a first direction (e.g., a direction substantially perpendicular to a flow of the air) across the first inlet 224. Further, when the first inlet valve 210 is at least partially open, adjacent vanes are separated from each other in a second direction (e.g., in a direction defined by the flow of the air) to define slots that form the cross-sectional area through which the air from the fan section 18 or the bypass passage 95, or both, can enter the first pipe 202 through the first inlet 224.

The vanes of the first inlet valve 210 are rotatable to enable adjustments to the cross-sectional area of the first inlet 224 through which the air can enter the first pipe 202. Additionally or alternatively, the vanes of the first inlet valve 210 can move into the airflow passage defined by the fan section 18 or the bypass passage 95. For example, the vanes can translate towards the airflow passage defined by the fan section 18 or the bypass passage 95 to cause at least a portion of at least one of the vanes to extend into the airflow passage defined by the fan section 18 or the bypass passage 95. Accordingly, a portion of the air flowing through the airflow passages that would otherwise flow past the first inlet 224 can contact the vanes, which guides (e.g., deflects) the air through the first inlet 224 and into the first pipe 202.

In the illustrated example of FIG. 3, the second inlet valve 212 is positioned at a second inlet 226 of the first pipe 202. The second inlet 226 receives air from (e.g., is in fluid connection with) the compressor section 22. In the illustrated example, a position (e.g., a configuration, an orientation, etc.) of the second inlet valve 212 affects a rate at which the air enters the first pipe 202 through the second inlet 226, as discussed in further detail below. As such, the second inlet valve 212 can affect a rate at which the air impinges on the surfaces of the flanges 206A, 206B and mid-rings 208A, 208B to help control the blade tip clearances in the HP turbine 34 and the LP turbine 36. In some examples, the second inlet valve 212 is substantially similar to (e.g., includes the same structure or functions as) the first inlet valve 210.

In the illustrated example of FIG. 3, the mid-pipe valve 214 is positioned between the inlets 224, 226 and the manifolds 204A, 204B, 204C (e.g., downstream of the inlets 224, 226 and upstream of the manifolds 204A, 204B, 204C). In the illustrated example of FIG. 3, a position (e.g., a configuration, an orientation, etc.) of the mid-pipe valve 214 can control a rate at which the air that enters the first pipe 202 encounters the manifolds 204A, 204B, 204C. As such, the mid-pipe valve 214 can affect a rate at which the air impinges on the surfaces of the flanges 206A, 206B and mid-rings 208A, 208B to help control the blade tip clearances in the HP turbine 34 and the LP turbine 36.

In the illustrated example of FIG. 3, when the mid-pipe valve 214 is at least partially open, the mid-pipe valve 214 is positioned around an opening in the first pipe 202 through which the air flows. In some examples, the opening is a circular opening approximately at a center of a cross-sectional area of the first pipe 202. The position or configuration of the mid-pipe valve 214 can affect the size of the opening and, in turn, the rate at which the air flows towards the manifolds 204A, 204B, 204C.

For example, the mid-pipe valve 214 can include rotatable swing wings positioned around the opening in the first pipe 202. In some examples, the mid-pipe valve 214 includes pivot rods to which the swing wings are coupled. Further, the pivot rods can be positioned between and supported by an inner bearing and an outer bearing. In some examples, a rotation of the outer bearing can cause the pivot rods to rotate and, in turn, move the swing wings to increase or decrease a size of the opening. In some examples, the swing wings include curvature defined along respective edges of the swing wings. In some examples, the curvature and an overlap of the swing wings causes the opening to be defined by a circular cross-sectional area through which the air flows towards the manifolds 204A, 204B, 204C. Moreover, the circular opening defined by the mid-pipe valve 214 enables the air to flow through an entirety of the opening. In other words, the circular opening defined by the mid-pipe valve 214 prevents or otherwise reduces turbulence in the first pipe 202 that would otherwise result from usage of other valves, such as a butterfly valve. In the illustrated example of FIG. 3, a positional adjustment of the mid-pipe valve 214 linearly increases or decreases a size of the circular opening to cause the rate at which the air is provided to the manifolds 204A, 204B, 204C to linearly increase or decrease. Accordingly, the mid-pipe valve 214 enables simple flow rate calculations and, thus, enables implementation of the mid-pipe valve 214 with a reduced burden resulting from testing or flow rate-to-valve position model development.

In the illustrated example of FIG. 3, the first actuators 216 and the second actuators 218 can cause the rotation of the vanes of the first inlet valve 210 and the second inlet valve 212, respectively. The first actuators 216 and the second actuators 218 can include any number of actuators to control the angular orientation of the vanes of the first inlet valve 210 and the second inlet valve 212, respectively. In some examples, the first actuators 216 and the second actuators 218 include an actuator that causes the rotation of all of the vanes of the first inlet valve 210 and the second inlet valve 212, respectively. For example, the first actuators 216 and the second actuators 218 can be coupled to a frame or a bracket of the first inlet valve 210 to which the vanes are rotatably coupled. In some examples, the first actuators 216 and the second actuators 218 include respective actuators to cause the rotation of the respective vanes. For example, the respective actuators of the first actuators 216 and the second actuators 218 can each be operatively coupled to, and drive a rotation of, one of the vanes.

Additionally or alternatively, the first actuators 216 and the second actuators 218 can move the vanes of the first inlet valve 210 and the second inlet valve 212, respectively, towards or away from the adjacent airflow passage. For example, the first actuators 216 and the second actuators 218 can cause the vanes of the first inlet valve 210 and the second inlet valve 212, respectively, to translate towards or away from the airflow passage defined by the fan section 18, the bypass passage 95, or an airflow passage defined by the compressor section 22. In some examples, the first actuators 216 and the second actuators 218 cause both upstream and downstream ends of the first inlet valve 210 and the second inlet valve 212, respectively, to translate. As a result, the first actuators 216 and the second actuators 218 can cause all of the vanes of the first inlet valve 210 and the second inlet valve 212, respectively, to protrude into the adjacent airflow passage. In some examples, the first actuators 216 and the second actuators 218 cause downstream ends of the first inlet valve 210 and the second inlet valve 212, respectively, to move towards the adjacent airflow passage. As such, the first actuators 216 and the second actuators 218 can cause downstream ones of the vanes to protrude into the adjacent airflow passage more than upstream ones of the vanes.

In the illustrated example of FIG. 3, the third actuators 220 control a size of the opening defined by the mid-pipe valve 214. For example, the third actuators 220 can cause a rotation of the outer bearing to rotate the pivot rods and, in turn, move the swing wings to open or close the opening. In some examples, the third actuators 220 rotate the pivot rods of the mid-pipe valve 214 directly.

The first actuators 216, the second actuators 218, and the third actuators 220 can be implemented by one or more types of actuators. For example, the first actuators 216, the second actuators 218, or the third actuators 220 can be implemented by at least one of a linear actuator, a rotary actuator, a hydraulic actuator, a pneumatic actuator, an electric actuator, etc. In some examples, the first actuators 216, the second actuators 218, or the third actuators 220 are implemented by at least one actuator that controls multiple movable parts of the respective valves 210, 212, 214. In some examples, the first actuators 216, the second actuators 218, or the third actuators 220 are implemented by a plurality of actuators that individually control movements of respective parts of the respective valves 206, 210, 214.

To control the air that the ACC system 200 utilizes to help control the blade clearance in the HP turbine 34 and the LP turbine 36, the ACC processor circuitry 222 controls respective positions of the first inlet valve 210, the second inlet valve 212, or the mid-pipe valve 214 based on signals from the sensors 132. In the illustrated example, the ACC processor circuitry 222 determines a blade tip clearance or a blade tip clearance change in the HP turbine 34 or the LP turbine 36 based on the signals from the sensors 132. For example, the ACC processor circuitry 222 can determine whether there is a contraction inward or an expansion outward of the flanges 206A, 206B and the mid-rings 208A, 208B based on the signals from the sensors 132. To control the contraction or expansion, the ACC processor circuitry 222 can determine a rate at which the air from the fan section 18, the bypass passage 95, or the compressor section 22 is to be provided to the flanges 206A, 206B and the mid-rings 208A, 208B.

In the illustrated example of FIG. 3, the ACC processor circuitry 222 controls respective positions of the first inlet valve 210, the second inlet valve 212, or the mid-pipe valve 214 based on the determined flow rate or temperature of the air to be utilized for blade clearance control. In particular, the ACC processor circuitry 222 modulates the positions of the first inlet valve 210, the second inlet valve 212, or the mid-pipe valve 214 through signals to the first actuators 216, the second actuators 218, or the third actuators 220, respectively, to optimize or otherwise improve the blade tip clearances in the HP turbine 34 and the LP turbine 36.

For example, the ACC processor circuitry 222 can generate and transmit a signal to the first actuators 216 to cause the first actuators 216 to adjust a position of the first inlet valve 210 and, in turn, adjust a rate at which the air enters the first inlet 224. Similarly, the ACC processor circuitry 222 can generate and transmit a signal to the second actuators 218 to cause the second actuators 218 to adjust a position of the second inlet valve 212 and, in turn, adjust a rate at which the air enters the second inlet 226. In some examples, the ACC processor circuitry 222 determines an angular orientation in which the vanes of the first inlet valve 210 or the vanes of the second inlet valve 212 are to be positioned based on signals from the sensors 132. In turn, the ACC processor circuitry 222 can cause the first actuators 216 and the second actuators 218 to modulate the angular orientation of the respective vanes based on the determined angular orientation. Furthermore, the ACC processor circuitry 222 can generate and transmit a signal to the third actuators 220 to cause the third actuators 220 to adjust a position of the mid-pipe valve 214 and, in turn, adjust a rate at which the air flows towards the manifolds 204A, 204B, 204C in the first pipe 202 based on the signals from the sensors 132.

In some examples, because there is a temperature difference between the air in the fan section 18 or the bypass passage 95 and the compressor section 22, the ACC processor circuitry 222 determines that the air from the fan section 18 or the bypass passage 95 is to be provided to the flanges 206A, 206B and the mid-rings 208A, 208B at a first rate and determine that the air from the compressor section 22 is to be provided to the flanges 206A, 206B and the mid-rings 230A at a second rate. Thus, the ACC processor circuitry 222 can configure the first inlet valve 210 and the second inlet valve 212 differently to control a temperature and flow rate of the air encountered by the flanges 206A, 206B and the mid-rings 230A for improved blade tip clearance control in the HP turbine 34 or the LP turbine 36. Controlling the temperature and flow rate of the air with the improved blade tip clearance control reduces the EGT following the HP turbine 34, allowing for the ACC processor circuitry 222 to assist in reducing the EGT to a target EGT.

The gas turbine engine 10 of FIGS. 1-3 is illustrated as a hybrid-electric gas turbine engine. However, the gas turbine engine 10 may be a different type of engine, such as a turboprop engine, a turbofan engine, an unducted engine, a ducted engine, or the like.

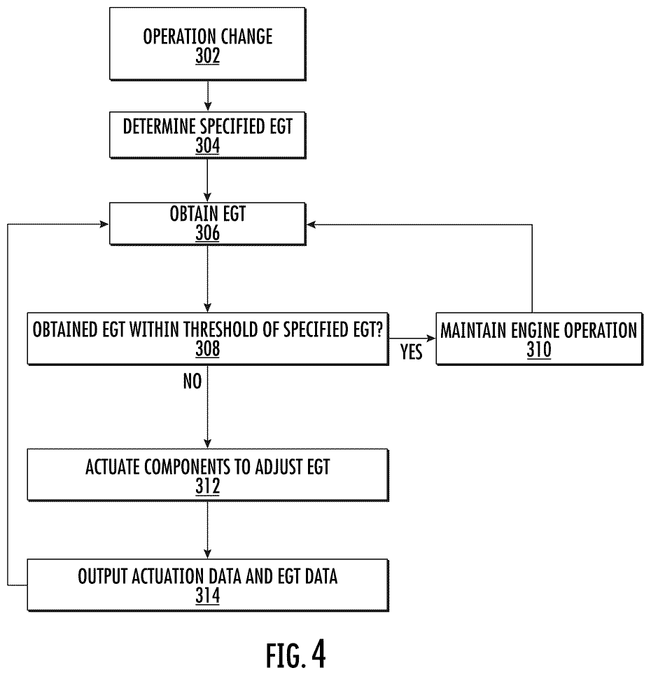

FIG. 4 is a block diagram of a method 300 to control EGT during a thrust change of the gas turbine engine 10. The method may be used during a takeoff engine condition, in which the acceleration of the gas turbine engine 10 (specifically, the acceleration rates of the HP turbine, the LP turbine, or both) is controlled to reduce EGT. Alternatively, the method may be used to adjust the ACC system to adjust an HP blade tip clearance 75 between the blade tips 85 of the HP turbine blades 82 and a radially inward surface of the core casing 46 or an LP turbine blade tip clearance 77 between the blade tips 87 of the LP turbine blades 84, adjusting the EGT.

The method 300 at (302) includes identifying a change in operation of the gas turbine engine 10. The change in operation can be a change in operation mode, such as changing from takeoff to cruise, or a change in thrust demand, such as a change in thrust output. The change in operation may include identifying one or more operation conditions of the gas turbine engine 10. As an example, the control module 142 may identify a change in thrust output of the gas turbine engine 10, the control module 142 may collect data from one or more sensors 132, such as altitude data, speed data, pressure data, or flowpath temperature data. Based on the collected data, the control module 142 may determine the current operation condition by comparing the collected data to a lookup table or the like.

The method 300 at (304) includes determining a specified EGT for the operation condition. The specified EGT is a target or predicted EGT that improves operation of the gas turbine engine 10 at the current operation condition. The control module 142 can determine the specified EGT based on collected data from the sensors 132, such as from a lookup table or a model. The lookup table may include specific values for EGT for specific values of collected data, such as altitude, engine speed, ambient air temperature, or combinations thereof. As an example, the control module 142 can determine the specified EGT based on output from a machine learning model, such as a neural network, trained with historical engine operation data. The historical engine operation data may be collected from prior flights from one or more aircraft, such as engine inlet temperature data, inlet compressor temperature data, exit compressor temperature data, shaft speed, air flow pressure, outputs from temperature models, or combinations thereof. The historical engine operation data may be combined with newly collected operation data to refine the machine learning model, such as with back propagation and gradient descent.

The method 300 at (306) includes obtaining temperature data indicating a current EGT. The control module 142 can collect data from temperature sensors 132 that measure a current temperature of exhaust gases from the gas turbine engine 10. Alternatively, the current EGT can be calculated based on other collected data, such as engine inlet temperature data, inlet compressor temperature data, exit compressor temperature data, shaft speed, air flow pressure, outputs from temperature models, or combinations thereof.

The method 300 at (308) includes determining whether the obtained EGT is within a threshold of the specified EGT. The threshold is a predetermined value that may be determined based on the identified operation condition. In general, the threshold indicates a tolerance or range around the specified EGT that allows for the improved operation of the gas turbine engine 10. The threshold may be a specific number, such as 10 degrees Celsius, or the threshold may be a percentage, such as 5%. If the obtained EGT is within the threshold of the specified EGT, the method 300 continues at (310). Otherwise, when the obtained EGT is outside the threshold of the specified EGT, the method 300 continues at (312).

The method 300 at (310) includes maintaining current operation of the gas turbine engine 10. Specifically, the control module 142 maintains current operation of the components of the gas turbine engine 10, such as the ACC system 200 and the electric machines 51, 52, to maintain the current EGT. The method 300 returns to (306) to obtain new temperature data of the current EGT.

The method 300 at (312) includes adjusting a component of the gas turbine engine 10 to adjust the EGT. For example, the control module 142 can adjust one or more components of a hybrid-electric engine, such as one or both of the electric machines 51, 52. As another example, the control module 142 may instruct the ACC processor circuitry 222 to actuate one or more components of the ACC system 200 to adjust a clearance. In addition or alternatively to adjusting the component, the control module 142 may identify adjustments to the component to be made in a post-flight or operation event or in a future flight, such as changing a target clearance value or adjusting a specified EGT value.

The method 300 includes at (314) outputting actuation data and EGT data. The control module 142, upon instructing the components to adjust the EGT, outputs data indicating the specific components actuated (such as the electric machines 51, 52 and/or the ACC system 200), the current and specified EGT, and the operation condition (such as takeoff, cruise, or landing) for use by other components. That is, “actuation data” includes all data regarding components actuated to control the EGT, and “EGT data” includes data indicating the specified EGT data, the obtained EGT data, and the threshold. As an example, the control module 142 may add the actuation data and the EGT data to a training database for use in training and updating a machine learning model that outputs the specified EGT temperature or a predicted EGT temperature, as described above. Following (314), the method returns to (306).

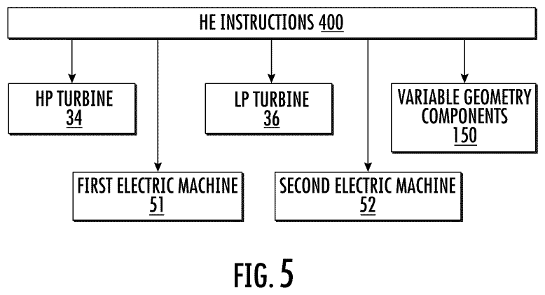

Now referring to FIG. 5, a schematic diagram of operation of a hybrid-electric gas turbine engine 10 is shown. As described above, to adjust the EGT, the control module 142 can adjust components of a hybrid-electric engine. The control module 142 can generate hybrid-electric engine (HE) instructions 400 for the components, which may include one or more of the HP turbine 34, the LP turbine 36, the first electric machine 51, the second electric machine 52, the variable geometry components 150, or combinations thereof. As an example, the HE instructions 400 may include instructions for actuating one or both of the electric machines 51, 52 to increase power to one or both of the HP turbine 34 or the LP turbine 36. As another example, the HE instructions 400 may include instructions for drawing power from one or both of the electric machines 51, 52. As yet another example, the HE instructions 400 may include instructions for adjusting one of the variable geometry components 150, such as a variable bleed valve, to increase power to the HP turbine 34, the LP turbine 36, or both. As yet another example, the HE instructions 400 may include instructions for adjusting fuel control schedules that adjust power to the HP turbine 34, the LP turbine 36, or both. Such control improves the ability to target independent specified operation of the HP turbine 34, the LP turbine 36, or both.

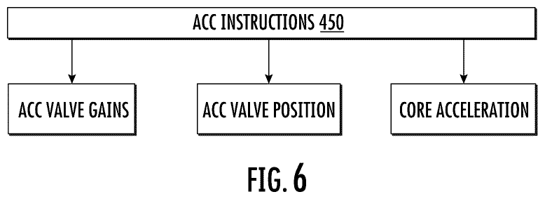

Now referring to FIG. 6, a schematic diagram of operation of the ACC system 200 is shown. As described above, to adjust the EGT, the control module 142 can adjust components of the ACC system 200 to control the blade tip clearances of the HP turbine 34 and the LP turbine 36. The control module 142 can generate ACC instructions 450 for adjusting one or more of the valves 210, 212, 214 of the ACC system 200 to adjust the blade tip clearances to specified blade tip clearances. Specifically, the ACC instructions 450 may include instructions for increasing a flow through one or more of the ACC valves 210, 212, 214 to decrease the blade tip clearance and decreasing the flow through one or more of the ACC valves 210, 212, 214 to increase the blade tip clearance.

As one example, the ACC instructions 450 may include instructions to adjust respective gains of one or more of the ACC valves 210, 212, 214. In this context, a “gain” of one of the ACC valves 210, 212, 214 is a measure of a change in flow through the respective valve 210, 212, 214 compared to a change in signal provided to the respective valve 210, 212, 214. That is, adjusting the gain of one of the ACC valves 210, 212, 214 adjust a sensitivity to which the ACC valve 210, 212, 214 responds to a provided signal. The gains of each of the ACC valves 210, 212, 214 may be specified for specific operation conditions, such as takeoff, cruise, and landing. When the control module 142 determines the current operation condition, the control module 142 can generate ACC instructions 450 to adjust the gains of the ACC valves 210, 212, 214 to the specified gains.

As another example, the ACC instructions 450 may include instructions to adjust a respective position of one or more of the ACC valves 210, 212, 214. The “position” of one of the ACC valves 210, 212, 214 is a measure of how open or closed the respective one of the ACC valves 210, 212, 214 is, which controls flow through the ACC valves 210, 212, 214. By adjusting the respective position of one or more of the ACC valves 210, 212, 214, the ACC instructions 450 control flow through the ACC valves 210, 212, 214, adjusting the blade tip clearances.

The ACC instructions 450 may include specified positions for each of the ACC valves 210, 212, 214 that are determined based on measured current blade tip clearances for the HP turbine 34 or the LP turbine 36 and specified blade tip clearances for the HP turbine 34 or the LP turbine 36. Specifically, the control module 142 may include specified blade tip clearances that provide a specified EGT, and the ACC instructions 450 may include instructions to adjust the positions of each of the ACC valves 210, 212, 214 to achieve the specified blade tip clearances. The specified blade tip clearances may be fixed values, fixed ranges including a clearance floor value and a clearance ceiling value, or adjustable values based on historical operation data. For example, the ACC instructions 450 may include instructions to maintain a current blade tip clearance above the clearance floor value.

The control module 142 can determine the current blade tip clearances of the HP turbine 34 and the LP turbine 36 based on at least one of: an engine speed, an altitude, a thrust rating, a compressor discharge pressure, or combinations thereof. Then, the control module 142 can generate ACC instructions 450 that adjust the respective positions of one or more of the ACC valves 210, 212, 214 to adjust the current blade tip clearances to the specified blade tip clearances. Upon reaching the specified blade tip clearances, the control module 142 can collect additional data of the EGT, compare the data to the specified EGT, and generate additional ACC instructions 450 to further control the ACC valves 210, 212, 214.

As another example, the ACC instructions 450 may include instructions to adjust a core acceleration of the gas turbine engine 10. In general, the ACC processor circuitry 222 may include instructions to actuate the ACC valves 210, 212, 214 according to a current acceleration of the turbine core 38, i.e., the “core acceleration,” which is a change in a core speed of the turbine core 38. Specifically, the ACC instructions 450 may include instructions to decrease the core acceleration to reduce increase of EGT during a current operation condition. The decrease in the core acceleration causes the ACC processor circuitry 222 to adjust the ACC valves 210, 212, 214 to increase the blade tip clearances of the HP turbine 34, the LP turbine 36, or both. The control module 142 can determine the specific core acceleration based on, e.g., historical data correlating EGT to core speed and acceleration, empirical testing data of EGT and core speed and acceleration, modeled data of EGT and core speed and acceleration, or combinations thereof.

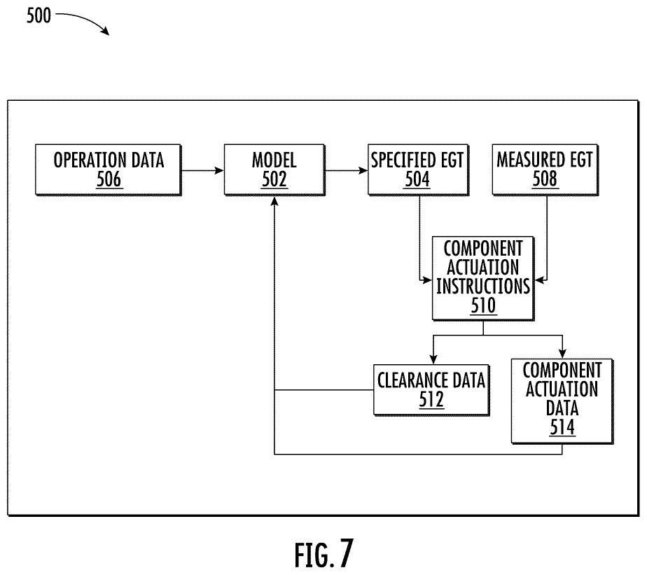

With reference to FIG. 7, a schematic diagram 500 of operation of the gas turbine engine 10. Specifically, the diagram 500 shows a model 502 used to determine a specified EGT 504 for the gas turbine engine 10. The model 502 may be used to determine the specified EGT 504 for operation of the gas turbine engine 10 described above in FIGS. 1-6.

The model 502 receives operation data 506 from one or more components of the gas turbine engine 10. The operation data 506 include data of one or more parameters, such as ambient pressure, ambient temperature, altitude, throttle position, and combinations thereof. In particular, the control module 142 can collect operation data 506 from the sensors 132 and can input the collected operation data 506 to the model 502. The control module 142 may collect the operation data prior to a takeoff operation condition or during the takeoff operation condition to determine the specified EGT prior to or while the gas turbine engine 10 is in the takeoff operation condition. As an example, the model 502 can determine the specified EGT 504 based prior to the gas turbine engine 10 initiating a take-off process, and the control module can update the specified EGT 504 during the take-off process until cruise. As another example, the model 502 can determine a predicted EGT for an entire flight, and the specified EGT 504 is a value of the predicted EGT at a current time.

The model 502 outputs the specified EGT 504 based on the input operation data 506. As an example, the model 502 may be a machine learning program, such as a neural network, that is trained with historical, empirical, and modeled operation data and EGT data. The model 502 may be a software program that is executable by the control module 142. In an exemplary implementation, the model 502 can include, but is not limited to, a convolutional neural network (CNN), a region-based CNN (R-CNN), Fast R-CNN, Faster R-CNN, Long Short-Term Memory (LSM), and Gated Recurrent Unit (GNU).

The control module 142 compares the specified EGT 504 to a measured EGT 508. As described above, the control module 142 can measure the measured EGT 508 based on data from the sensors 132. Based on the specified EGT 504 and the measured EGT 508, the control module 142 can determine component actuation instructions 510, such as the HE instructions 400 or the ACC instructions 450 described above. The component actuation instructions 510 may include instructions to actuate components to adjust a blade tip clearance of the HP turbine 34 or the LP turbine 36, or to actuate one of the electric machines 51, 52, or to maintain current operation of the gas turbine engine 10, or combinations thereof. As described above, the specified EGT 504 can be a value of the predicted EGT predicted at the specific time at which the control module 142 determines the measured EGT 508.

Upon implementing the component actuation instructions 510, the control module 142 collects clearance data 512 indicating the blade tip clearances of the HP turbine 34, the LP turbine 36, or both, and component actuation data 514. The clearance data 512 may include data indicating the blade tip clearances prior to implementation of the component actuation instructions 510, during implementation of the component actuation instructions 510, after implementation of the component actuation instructions, or combinations thereof. The component actuation data 514 include data indicating which components of the gas turbine engine 10 were actuated based on the component actuation instructions 510 and the changes in settings or values of the components. For example, the component actuation data 514 may include the components actuated according to the HE instructions 400 or the ACC instructions 450 described above. The control module 142 includes the clearance data 512 and the component actuation data 514 to a database from which the model 502 may be updated or retrained. By using the clearance data 512 and the component actuation data 514 in actual flight conditions, the model 502 may more accurately specify the specified EGT 504.

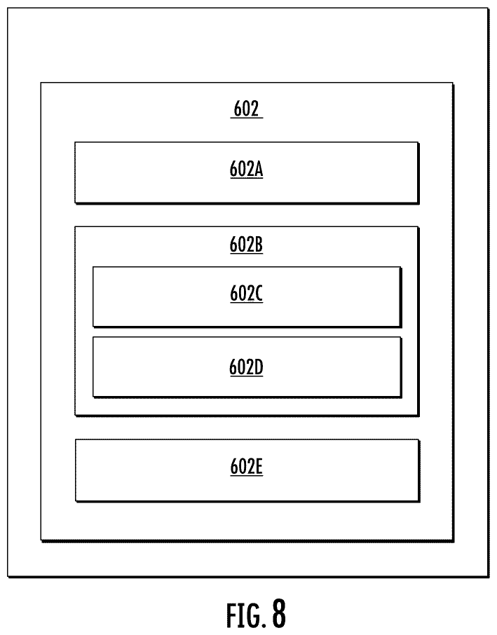

Now referring to FIG. 8, the operation of a controller 600, which may be the control module 142, will be described. In at least certain embodiments, the controller 600 can include one or more computing devices 602. The computing devices 602 can include one or more processors 602A and one or more memory devices 602B. The one or more processors 602A can include any suitable processing device, such as a microprocessor, microcontroller, integrated circuit, logic device, and/or other suitable processing device. The one or more memory devices 602B can include one or more computer-readable media, including, but not limited to, non-transitory computer-readable media, RAM, ROM, hard drives, flash drives, and/or other memory devices.

The one or more memory devices 602B can store information accessible by the one or more processors 602A, including computer-readable instructions 602C that can be executed by the one or more processors 602A. The instructions 602C can be any set of instructions that when executed by the one or more processors 602A, cause the one or more processors 602A to perform operations. In some embodiments, the instructions 602C can be executed by the one or more processors 602A to cause the one or more processors 602A to perform operations, such as any of the operations and functions for which the controller 600 and/or the computing devices 602 are configured, the operations for operating power source assemblies as described herein, and/or any other operations or functions of the one or more computing devices 602.

The instructions 602C can be software written in any suitable programming language or can be implemented in hardware. Additionally, and/or alternatively, the instructions 602C can be executed in logically and/or virtually separate threads on the one or more processors 602A. The one or more memory devices 602B can further store data 602D that can be accessed by the one or more processors 602A. For example, the data 602D can include data indicative of power flows, data indicative of engine/aircraft parameters, and/or any other data and/or information described herein.

The computing devices 602 can also include a network interface 602E used to communicate, for example, with the other components of the power source assemblies, the vehicle incorporating the power source assemblies. For example, in the embodiment depicted, as noted above, the power source assemblies include one or more sensors for sensing data indicative of one or more parameters (e.g., power level, current level, voltage). The controller 600 is operably coupled to the one or more sensors through, e.g., the network interface, such that the controller 600 may receive data indicative of various operating parameters sensed by the one or more sensors during operation. In such a manner, the controller 600 may be configured to operate the power source assemblies in response to, e.g., the data sensed by the one or more sensors.

The network interface 602E can include any suitable components for interfacing with one or more networks, including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Controlling the exhaust gas temperature can improve operation of a gas turbine engine by reducing wear on engine components and extending time on wing. Control valves and electric machines provide clearance control for turbines, which adjust the exhaust gas temperature to specified ranges. Such components provide control of the exhaust gas temperature without reducing thrust of the gas turbine engine, maintaining specified performance of the gas turbine engine during operation. In particular, hybrid-electric engines benefit from more favorable blade tip clearance or seal tooth clearance without reducing output.

Further aspects are provided by the subject matter of the following clauses:

An assembly for an aircraft includes a gas turbine engine including a turbine and a casing, and a system including a processor and a memory, the memory storing instructions executable by the processor to determine an exhaust gas temperature based on data from one or more sensors disposed in the gas turbine engine, the exhaust gas temperature being a temperature of an airflow downstream of the turbine, determine whether the exhaust gas temperature of the gas turbine engine is within a threshold of a specified exhaust gas temperature, and upon determining that the exhaust gas temperature is outside the threshold of the specified exhaust gas temperature, control at least one of an electric machine operably connected to the turbine or an active clearance control valve to adjust a clearance between two components of the gas turbine engine until a current exhaust gas temperature is within the threshold of the specific exhaust gas temperature.

The assembly of any of the preceding clauses, wherein the instructions to control at least one of the electric machine or the active clearance control valve further include instructions to actuate the electric machine operably connected to the turbine or draw power from the electric machine.

The assembly of any of the preceding clauses, wherein the instructions further include instructions to maintain a current clearance above a clearance floor value.

The assembly of any of the preceding clauses, wherein the instructions further include instructions to adjust a flow through the active clearance control valve to adjust the clearance.

The assembly of any of the preceding clauses, wherein the instructions further include instructions to identify a change in a thrust output of the gas turbine engine and, then, determine whether the exhaust gas temperature of the gas turbine engine is within the threshold of the specified exhaust gas temperature.

The assembly of any of the preceding clauses, wherein the instructions further include instructions to determine the specified exhaust gas temperature based on output from a machine learning program provided prior to the gas turbine engine initiating a take-off process.

The assembly of any of the preceding clauses, wherein the instructions further include instructions to determine an operation condition of the gas turbine engine and to determine the specified exhaust gas temperature based on the determined operation condition.

The assembly of any of the preceding clauses, further including a temperature sensor downstream of the turbine, wherein the instructions further include instructions to determine the exhaust gas temperature based on data from the temperature sensor.

A method includes determining an exhaust gas temperature of a gas turbine engine, the exhaust gas temperature being a temperature of an airflow downstream of a turbine of the gas turbine engine, determining whether the exhaust gas temperature of the gas turbine engine is within a threshold of a specified exhaust gas temperature, and upon determining that the exhaust gas temperature is outside the threshold of the specified exhaust gas temperature, adjusting a clearance between two components of the gas turbine engine until a current exhaust gas temperature is within the threshold of the specified exhaust gas temperature.

The method of any of the preceding clauses, wherein the gas turbine engine is a hybrid-electric engine, and wherein the method further includes at least one of actuating an electric machine operably connected to a turbine of the hybrid-electric engine or drawing power from the electric machine.

The method of any of the preceding clauses, wherein adjusting the clearance further includes maintaining a current clearance above a clearance floor value.

The method of any of the preceding clauses, further including determining the current clearance based on at least one of an engine speed, an altitude, a thrust rating, a compressor discharge pressure, or combinations thereof.

The method of any of the preceding clauses, wherein adjusting the clearance includes increasing a flow through an active clearance control valve to decrease the clearance and decreasing the flow through the active clearance control valve to increase the clearance.

The method of any of the preceding clauses, further including determining the specified exhaust gas temperature based on collected operation data of the gas turbine engine.

The method of any of the preceding clauses, further including identifying a change in a thrust output of the gas turbine engine and, then, determining whether the exhaust gas temperature of the gas turbine engine is within the threshold of the specified exhaust gas temperature.

The method of any of the preceding clauses, further including, after identifying the change in the thrust output, identifying one or more operation conditions and, based on the one or more operation conditions, determining whether the exhaust gas temperature of the gas turbine engine is within the threshold of the specified exhaust gas temperature.

The method of any of the preceding clauses, further including determining the specified exhaust gas temperature based on output from a machine learning program provided prior to the gas turbine engine initiating a take-off process.

The method of any of the preceding clauses, wherein determining the specified exhaust gas temperature includes outputting, from the machine learning program a predicted exhaust gas temperature for an entire flight, and the specified exhaust gas temperature is a value of the predicted exhaust gas temperature at a specific time at which the exhaust gas temperature of the gas turbine engine is measured.

The method of any of the preceding clauses, further including collecting operation data from a turbine and adding the collected operation data to a training database for training the machine learning program.

The method of any of the preceding clauses, wherein adjusting the clearance includes actuating a variable geometry component

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An assembly for an aircraft, the assembly comprising:
a gas turbine engine comprising a turbine and a casing; and
a system comprising a processor and a memory, the memory storing instructions executable by the processor to:
determine an exhaust gas temperature based on data from one or more sensors disposed in the gas turbine engine, the exhaust gas temperature being a temperature of an airflow downstream of the turbine;
determine whether the exhaust gas temperature of the gas turbine engine is within a threshold of a specified exhaust gas temperature; and
upon determining that the exhaust gas temperature is outside the threshold of the specified exhaust gas temperature, control at least one of an electric machine operably connected to the turbine or an active clearance control valve to adjust a clearance between two components of the gas turbine engine until a current exhaust gas temperature is within the threshold of the specific exhaust gas temperature.

2. The assembly of claim 1, wherein the instructions to control at least one of the electric machine or the active clearance control valve further include instructions to:
actuate the electric machine operably connected to the turbine; or
draw power from the electric machine.

3. The assembly of claim 1, wherein the instructions further include instructions to maintain a current clearance above a clearance floor value.

4. The assembly of claim 1, wherein the instructions further include instructions to adjust a flow through the active clearance control valve to adjust the clearance.

5. The assembly of claim 1, wherein the instructions further include instructions to identify a change in a thrust output of the gas turbine engine and, then, determine whether the exhaust gas temperature of the gas turbine engine is within the threshold of the specified exhaust gas temperature.

6. The assembly of claim 1, wherein the instructions further include instructions to determine the specified exhaust gas temperature based on output from a machine learning program provided prior to the gas turbine engine initiating a take-off process.

7. The assembly of claim 1, wherein the instructions further include instructions to determine an operation condition of the gas turbine engine and to determine the specified exhaust gas temperature based on the determined operation condition.

8. The assembly of claim 1, further comprising a temperature sensor downstream of the turbine, wherein the instructions further include instructions to determine the exhaust gas temperature based on data from the temperature sensor.

9. A method comprising:
determining an exhaust gas temperature of a gas turbine engine, the exhaust gas temperature being a temperature of an airflow downstream of a turbine of the gas turbine engine;
determining whether the exhaust gas temperature of the gas turbine engine is within a threshold of a specified exhaust gas temperature; and
upon determining that the exhaust gas temperature is outside the threshold of the specified exhaust gas temperature, controlling at least one of an electric machine operably connected to the turbine or an active clearance control valve to adjust a clearance between two components of the gas turbine engine until a current exhaust gas temperature is within the threshold of the specified exhaust gas temperature.

10. The method of claim 9, wherein the gas turbine engine is a hybrid-electric engine, and wherein the method further comprises at least one of:
actuating an electric machine operably connected to a turbine of the hybrid-electric engine; or
drawing power from the electric machine.

11. The method of claim 9, wherein controlling at least one of an electric machine operably connected to the turbine or an active clearance control valve to adjust a clearance between two components of the gas turbine engine adjusting the clearance further comprises maintaining a current clearance above a clearance floor value.

12. The method of claim 11, further comprising determining the current clearance based on at least one of an engine speed, an altitude, a thrust rating, a compressor discharge pressure, or combinations thereof.

13. The method of claim 9, wherein controlling at least one of an electric machine operably connected to the turbine or an active clearance control valve to adjust a clearance between two components of the gas turbine engine the clearance comprises increasing a flow through the active clearance control valve to decrease the clearance and decreasing the flow through the active clearance control valve to increase the clearance.

14. The method of claim 9, further comprising determining the specified exhaust gas temperature based on collected operation data of the gas turbine engine.

15. The method of claim 9, further comprising identifying a change in a thrust output of the gas turbine engine and, then, determining whether the exhaust gas temperature of the gas turbine engine is within the threshold of the specified exhaust gas temperature.

16. The method of claim 15, further comprising, after identifying the change in the thrust output, identifying one or more operation conditions and, based on the one or more operation conditions, determining whether the exhaust gas temperature of the gas turbine engine is within the threshold of the specified exhaust gas temperature.

17. The method of claim 9, further comprising determining the specified exhaust gas temperature based on output from a machine learning program provided prior to the gas turbine engine initiating a take-off process.

18. The method of claim 17, wherein determining the specified exhaust gas temperature includes outputting, from the machine learning program a predicted exhaust gas temperature for an entire flight, and the specified exhaust gas temperature is a value of the predicted exhaust gas temperature at a specific time at which the exhaust gas temperature of the gas turbine engine is measured.

19. The method of claim 17, further comprising collecting operation data from a turbine and adding the collected operation data to a training database for training the machine learning program.

20. The method of claim 9, wherein controlling at least one of an electric machine operably connected to the turbine or an active clearance control valve to adjust a clearance between two components of the gas turbine engine the clearance comprises actuating a variable geometry component.
